(19) United States
(12) Patent Application Publication
(10) Pub. No.: US 2017/0123781 A1
(43) Pub. Date: May 4, 2017

(54) METHOD, DEVICE AND SYSTEM FOR APPLICATION UPDATING

(71) Applicant: Xiaomi Inc., Beijing (CN)

(72) Inventors: Shuai CHEN, Beijing (CN); Tiejun LIU, Beijing (CN); Xiangyang ZHANG, Beijing (CN)

(73) Assignee: Xiaomi Inc., Beijing (CN)

(21) Appl. No.: 15/066,627

(22) Filed: Mar. 10, 2016

(30) Foreign Application Priority Data
Oct. 29, 2015 (CN) 201510719836.1

(51) Int. Cl. G06F 9/445; H04L 12/26; H04L 29/08

(52) U.S. Cl. CPC G06F 8/65; H04L 67/34; H04L 43/16; H04L 43/0876

(57) ABSTRACT

A method, device and system for Application (APP) updating are provided. The method includes acquiring an APP list to be updated, downloading an installation file of an APP to be updated according to the APP list to be updated, and controlling a target terminal to install the installation file.

### CROSS-REFERENCE TO RELATED APPLICATIONS

This application is filed based upon and claims priority to Chinese Patent Application No. 201510719836.1 filed on Oct. 29, 2015, the entire contents of which are incorporated herein by reference.

### TECHNICAL FIELD

The present disclosure generally relates to the technical field of wireless communications, and more particularly, to a method, device and system for Application (APP) updating.

### BACKGROUND

At present, an operating system of a terminal provides an APP upgrading manner, that is, providing silent upgrading of an installation file using WIFI. Although an APP upgrading process is simplified, the silent upgrading of a great number of APPs and the centralized downloading of installation packages every time a user is connected to WIFI may cause network congestion and harm to a user's experience.

### SUMMARY

According to a first aspect of the embodiments of the present disclosure, a method for APP updating is provided, which may include acquiring an APP list to be updated, downloading an installation file of an APP to be updated according to the APP list to be updated, and controlling a target terminal to install the installation file.

According to a second aspect of the embodiments of the present disclosure, a method for APP updating is provided, which may include acquiring an installation file of an APP to be updated from a router, and updating the APP to be updated according to the installation file.

According to a third aspect of the embodiments of the present disclosure, a system for APP updating is provided, which may include a router, configured to acquire an APP list to be updated and download an installation file of an APP to be updated according to the APP list to be updated, a network side, configured to send the installation file of the APP to be updated to the router, and a terminal, configured to acquire the installation file of the APP to be updated from the router and update the APP to be updated according to the installation file.

According to a fourth aspect of the embodiments of the present disclosure, a device for APP updating is provided, which may be applied to a router, the device including an acquisition module, configured to acquire an APP list to be updated, a downloading module, configured to download an installation file of an APP to be updated according to the APP list to be updated acquired by the acquisition module, and a control module, configured to control a target terminal to install the installation file downloaded by the downloading module.

According to a fifth aspect of the embodiments of the present disclosure, a device for APP updating is provided, which may include an acquisition module, configured to acquire an installation file of an APP to be updated from a router, and an updating module, configured to update the APP to be updated according to the installation file acquired by the acquisition module.

According to a sixth aspect of the embodiments of the present disclosure, a device for APP updating is provided, which may include a processor, and a memory configured to store an instruction executable by the processor, wherein the processor may be configured to acquire an APP list to be updated, download an installation file of an APP to be updated according to the APP list to be updated, and download an installation file of an APP to be updated according to the APP list to be updated, and control a target terminal to install the installation file.

According to a seventh aspect of the embodiments of the present disclosure, a device for APP updating is provided, which may include a processor, and a memory configured to store an instruction executable by the processor. The processor may be configured to acquire an installation file of an APP to be updated from a router, and update the APP to be updated according to the installation file.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the embodiments of the present disclosure.

FIG. 1 is a block diagram of a system for APP updating according to an exemplary embodiment.

FIG. 2 is a block diagram of a system for APP updating according to another exemplary embodiment.

FIG. 3 is a block diagram of a device for APP updating according to an exemplary embodiment.

FIG. 4 is a block diagram of an acquisition module according to an exemplary embodiment.

FIG. 5 is a block diagram of an acquisition module according to another exemplary embodiment.

FIG. 6 is a block diagram of an acquisition module according to another exemplary embodiment.

FIG. 7 is a block diagram of a downloading module according to an exemplary embodiment.

FIG. 8 is a block diagram of a downloading module according to another exemplary embodiment.

FIG. 9 is a block diagram of a device for APP updating according to another exemplary embodiment.

FIG. 10 is a block diagram of an acquisition module according to an exemplary embodiment.

FIG. 11 is a block diagram of a device for APP updating according to an exemplary embodiment.

FIG. 12 is a block diagram of a device for APP updating according to another exemplary embodiment.

FIG. 13 is a block diagram of a device for APP updating according to another exemplary embodiment.

FIG. 14 is a block diagram of a device for APP updating according to another exemplary embodiment.

FIG. 15 is a block diagram of a device for APP updating according to another exemplary embodiment.

FIG. 16 is a flow chart showing a method for APP updating according to an exemplary embodiment.

FIG. 17 is a flow chart showing a method for APP updating according to another exemplary embodiment.

FIG. 18 is a flow chart showing a method for APP updating according to another exemplary embodiment.

FIG. 19 is a flow chart showing a method for APP updating according to another exemplary embodiment.

FIG. 20 is a flow chart showing a method for APP updating according to another exemplary embodiment.

FIG. 21 is a flow chart showing a method for APP updating according to an exemplary embodiment.

FIG. 22 is a flow chart showing a method for APP updating according to an exemplary embodiment.

FIG. 23 is a block diagram of a device for APP updating according to an exemplary embodiment.

FIG. 24 is a block diagram of a device for APP updating according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementation modes consistent with the embodiments of the present disclosure. Instead, they are merely examples of apparatuses and methods consistent with aspects related to the embodiments of the present disclosure as recited in the appended claims.

Three parties are involved in the technical solutions provided by the embodiment of the present disclosure, which respectively are: a network-side server, a terminal, and a router. The terminal may be any piece of equipment with a network connection function, such as a mobile phone, a computer, a digital broadcast terminal, a message transceiver, a gaming console, a tablet device, a medical device, fitness equipment, a personal digital assistant, and the like.

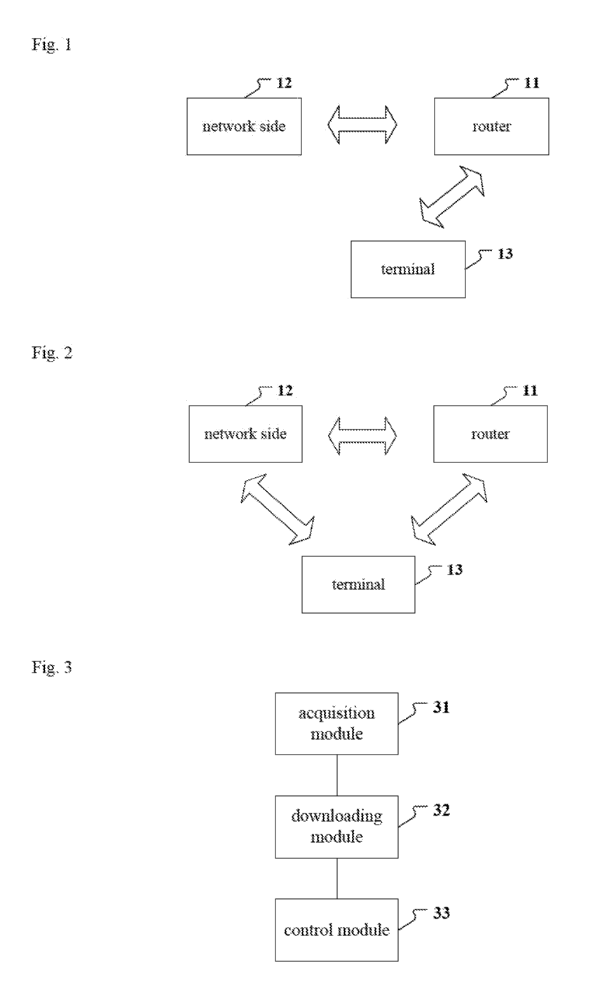

FIG. 1 is a block diagram of a system for APP updating according to an exemplary embodiment. As shown in FIG. 1, the system 10 for APP updating includes a router 11 configured to acquire an APP list to be updated and download an installation file of an APP to be updated according to the APP list to be updated. The system 10 can further include a network side 12 that is configured to send the installation file of the APP to be updated to the router and a terminal 13 configured to acquire the installation file of the APP to be updated from the router and update the APP to be updated according to the installation file.

For example, the APP list to be updated acquired by the router 11 may include five APPs to be updated: APP1, APP2, APP3, APP4 and APP5. The router 11 downloads installation files of the five APPs to be updated from the network side 12. The terminal 13 directly acquires the installation files of the APPs to be updated from the router 11 for updating.

In the embodiment, the router downloads the installation files of the APPs to be updated in advance, and the terminal acquires the installation files from the router when updating the APPs. In such a manner, data may be directly downloaded from the router faster, so that an APP updating speed is increased, and moreover, for a user, network congestion caused by centralized downloading of installation files may be avoided. In addition, a silent manner is still adopted for an APP updating process, that is, the user is not required to execute upgrading installation operation, and the terminal automatically updates the APP.

In another embodiment, there may be multiple manners for the router 11 to acquire the APP list to be updated, and are specifically described below.

Manner A1: the network side 12 generates an APP list to be updated according to APP information periodically sent by the terminal 13, and sends the APP list to be updated to the router 11.

FIG. 2 is a block diagram of a system for APP updating according to another exemplary embodiment. As shown in FIG. 2, the terminal 13 in the system is further configured to periodically send local APP information to the network side 12, the APP information including an APP identifier and a version number. The network side 12 is further configured to determine the APP to be updated of the terminal according to the APP information, generate an APP list to be updated and send the APP list to be updated to the router 11.

In manner A1, the terminal periodically sends local APP identifier and version number to the network side, and the network side queries a version of the corresponding APP in an APP store to determine the APP to be updated, generate the APP list to be updated and send the APP list to be updated to the router. In such a manner, the router can download the installation file of the APP to be updated in advance and then the terminal can acquire the installation file from the router when updating the APP. Since data may be directly downloaded from the router faster, the APP updating speed is increased, and moreover, for the user, network congestion caused by the centralized downloading of the installation files may be avoided. In addition, the silent manner is still adopted for the APP updating process, that is, the user is not required to execute the upgrading installation operation, and the terminal automatically updates the APP.

In addition, the network side may query a version state of the APP in real time, so that the network side may determine the APP to be updated more accurately and comprehensively.

Manner A2: the terminal 13 generates an APP list to be updated, and sends the APP list to be updated to the router 11.

As shown in FIG. 1, the terminal 13 is further configured to periodically detect a local APP to be updated, generate an APP list to be updated according to the APP to be updated and send the APP list to be updated to the router 11.

In manner A2, the terminal determines an APP to be updated by itself, generates an APP list to be updated and sends the APP list to be updated to the router. Therefore, the router can download the installation file of the APP to be updated in advance and then the terminal can acquire the installation file from the router when updating the APP. In such a manner, data may be directly downloaded from the router faster, so that the APP updating speed is increased, and moreover, for the user, network congestion caused by the centralized downloading of the installation files may be avoided. In addition, the silent manner is still adopted for the APP updating process, that is, the user is not required to execute the upgrading installation operation, and the terminal automatically updates the APP.

Manner A3: the router 11 periodically sends APP information to the terminal 13, detects an APP to be updated, and generates an APP list to be updated.

As shown in FIG. 1, the terminal 13 is further configured to periodically send local APP information to the router 11, the APP information including an APP identifier and a version number. The router 11 is further configured to monitor the APP to be updated according to the APP information, generate an APP list to be updated and download the installation file of the APP to be updated.

In manner A3, the terminal periodically sends the local APP identifier and version number to the router, and the router determines the APP to be updated and generates the APP list to be updated. Therefore, the router can download the installation file of the APP to be updated in advance and then the terminal can acquire the installation file from the router when updating the APP. In such a manner, data may be directly downloaded from the router faster, so that the APP updating speed is increased, and moreover, for the user, network congestion caused by the centralized downloading of the installation files may be avoided. In addition, the silent manner is still adopted for the APP updating process, that is, the user is not required to execute the upgrading installation operation, and the terminal automatically updates the APP.

In any one of the abovementioned three manners, the router can acquire the APP list to be updated. Any two manners in the three manners or the three manners may also be combined to enable the router to acquire the APP list to be updated. If the router acquires multiple APP lists to be updated, the router may compare APPs in each list to finally determine an APP of which an installation file is required to be downloaded.

In another embodiment, the router is limited in storage capacity, and may not keep all downloaded installation files all the time. Therefore, the terminal 13 is further configured to, in response to determination that the APP to be updated has been updated or the APP to be updated has been uninstalled, control the router to delete the installation file. The router 11 is further configured to delete the installation file.

In the embodiment, the router does not keep the installation file of the updated or uninstalled APP of the terminal, so that a storage space of the router is effectively saved.

The embodiments of the present disclosure further provide a device for APP updating, which should be configured as a router. FIG. 3 is a block diagram of a device for APP updating according to an exemplary embodiment. The device may be implemented as part or all of electronic equipment by virtue of software, hardware or a combination of the two. As shown in FIG. 3, the device can include an acquisition module 31, configured to acquire an APP list to be updated, a downloading module 32, configured to download an installation file of an APP to be updated according to the APP list to be updated acquired by the acquisition module 31, and a control module 33, configured to control a target terminal to install the installation file downloaded by the downloading module 32.

In the embodiment, the acquisition module 31 of the router acquires the APP list to be updated, the downloading module 32 downloads the installation file of the APP to be updated according to the APP list to be updated, and the control module 33 controls the target terminal to install the installation file. Therefore, the terminal acquires the installation file from the router when updating the APP. In such a manner, data may be directly downloaded from the router faster, so that an APP updating speed is increased, and moreover, for a user, network congestion caused by centralized downloading of installation files may be avoided. In addition, a silent manner is still adopted for an APP updating process, that is, the user is not required to execute upgrading installation operation, and the terminal automatically updates the APP.

In another embodiment, there may be multiple manners for the acquisition module 31 to acquire the APP list to be updated, and are specifically described below.

Manner B1: the acquisition module 31 generates the APP list to be updated by itself.

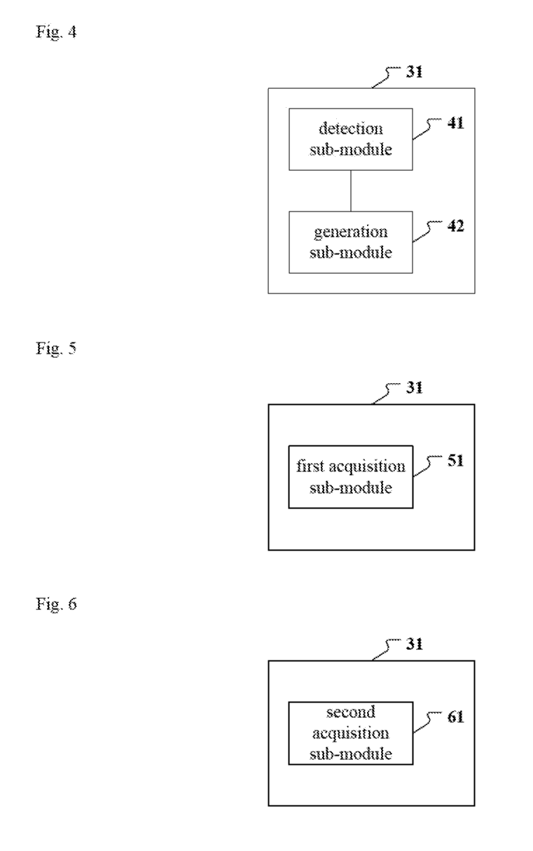

FIG. 4 is a block diagram of an acquisition module according to an exemplary embodiment. As shown in FIG. 4, the acquisition module 31 can include a detection sub-module 41, configured to detect the APP to be updated, and a generation sub-module 42, configured to, in response to that the detection sub-module 41 detects the APP to be updated, generate the APP list to be updated.

In manner B1, the router determines the APP to be updated by itself, the detection sub-module 41 detects the APP to be updated, and the generation module 42 generates the APP list to be updated. Therefore, the router can download the installation file of the APP to be updated in advance and then the terminal can acquire the installation file from the router when updating the APP. In such a manner, data may be directly downloaded from the router faster, so that the APP updating speed is increased, and moreover, for the user, network congestion caused by the centralized downloading of the installation files may be avoided. In addition, the silent manner is still adopted for the APP updating process, that is, the user is not required to execute the upgrading installation operation, and the terminal automatically updates the APP.

Manner B2: the APP list to be updated is acquired from the terminal.

FIG. 5 is a block diagram of an acquisition module according to another exemplary embodiment. As shown in FIG. 5, the acquisition module 31 includes a first acquisition sub-module 51 configured to acquire the APP list to be updated from the target terminal.

In manner B2, the terminal determines the APP to be updated by itself, and the first acquisition sub-module 51 acquires the APP list to be updated from the terminal. Therefore, the router can download the installation file of the APP to be updated in advance and then the terminal can acquire the installation file from the router when updating the APP. In such a manner, data may be directly downloaded from the router faster, so that the APP updating speed is increased, and moreover, for the user, network congestion caused by the centralized downloading of the installation files may be avoided. In addition, the silent manner is still adopted for the APP updating process, that is, the user is not required to execute the upgrading installation operation, and the terminal automatically updates the APP.

Manner B3: the APP list to be updated is acquired from a network side.

FIG. 6 is a block diagram of an acquisition module according to another exemplary embodiment. As shown in FIG. 6, the acquisition module 31 includes a second acquisition sub-module 61 configured to acquire the APP list to be updated from the network side.

In manner B3, the network side determines the APP to be updated and generates the APP list to be updated, and the second acquisition sub-module 61 acquires the APP list to be updated from the network side. Therefore, the router can download the installation file of the APP to be updated in advance and then the terminal can acquire the installation file from the router when updating the APP. Since data may be directly downloaded from the router faster, so that the APP updating speed is increased, and moreover, for the user, network congestion caused by the centralized downloading of the installation files may be avoided. In addition, the silent manner is still adopted for the APP updating process, that is, the user is not required to execute the upgrading installation operation, and the terminal automatically updates the APP.

In addition, the network side may query a version state of the APP in real time, so that the network side may determine the APP to be updated more accurately and comprehensively.

In any one of the abovementioned three manners, it may be implemented that the router acquires the APP list to be updated. Any two manners in the three manners or the three manners may also be combined to enable the router to acquire the APP list to be updated.

For example, the acquisition module 31 includes the detection sub-module 41, the generation sub-module 42 and the first acquisition sub-module 51. Or, the acquisition module 31 includes the detection sub-module 41, the generation sub-module 42 and the second acquisition sub-module 61. Or, the acquisition module 31 includes the first acquisition sub-module 51 and the second acquisition sub-module 61. Or, the acquisition module 31 includes the detection sub-module 41, the generation sub-module 42, the first acquisition sub-module 51 and the second acquisition sub-module 61.

If the router acquires multiple APP lists to be updated, a comparison sub-module may be added in the acquisition module to finally determine an APP of which an installation file is required to be downloaded after comparing APPs to be updated in each list.

In another embodiment, the router may choose when to download the installation file of the APP to be updated, and there may be multiple manners as follows.

Manner C1, the installation file is downloaded at preset time.

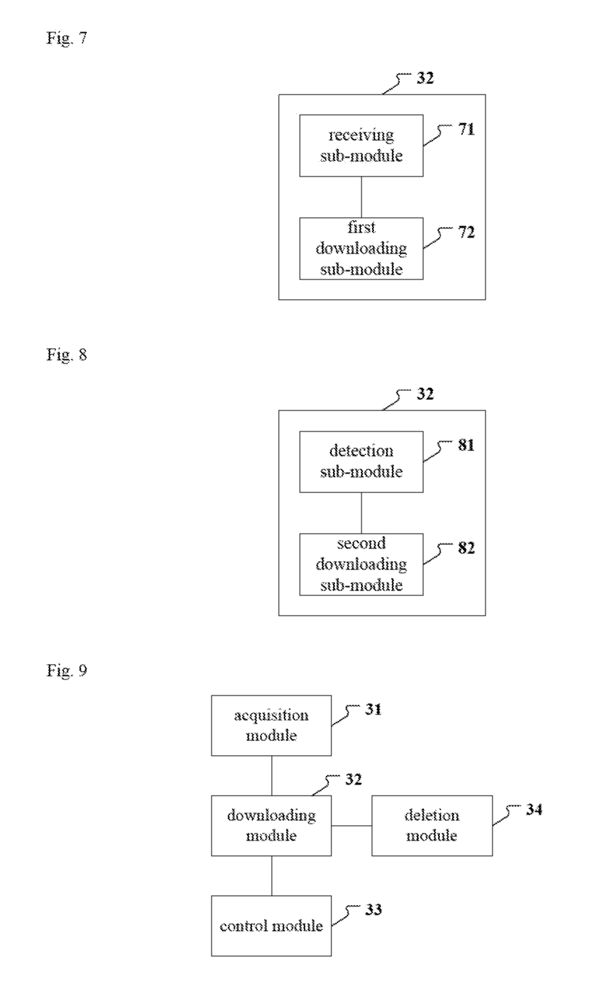

FIG. 7 is a block diagram of a downloading module according to an exemplary embodiment. As shown in FIG. 7, the downloading module 32 can include a receiving sub-module 71, configured to receive the preset time sent by the target terminal, and a first downloading sub-module 72, configured to, in response to determination that the preset time received by the receiving sub-module 71 is reached, download the installation file from the network side according to the APP list to be updated.

For example, the user may make such a setting that the router executes downloading of the installation file between 12:00 PM and 5:00 AM through the terminal, and during this time, the user is usually in a sleep state and may not use a network, and the router is relatively idle, so that downloading during this time may avoid network congestion and influence on use of the user over the network, and thus better user experience may be achieved.

In manner C1, the first downloading sub-module 72 downloads the installation file according to the preset time received by the receiving sub-module 71 to avoid network congestion and influence on the use of the user over the network and achieve better user experience.

Manner C2: the installation file is downloaded during idle time of the router.

FIG. 8 is a block diagram of a downloading module according to another exemplary embodiment. As shown in FIG. 8, the downloading module 32 includes a detection sub-module 81, configured to detect network data traffic, and a second downloading sub-module 82, configured to, in response to determination that the network data traffic is less than or equal to preset network data traffic, download the installation file from the network side according to the APP list to be updated.

For example, when the detection sub-module 81 detects that the network data traffic is lower than 10 kb/s, the router is relatively idle, and the second downloading sub-module 82 downloads the installation file of the APP to be updated to avoid network congestion and influence on use of the user over the network and achieve better user experience.

In manner C2, the second downloading sub-module 82 downloads the installation file of the APP to be updated to avoid network congestion and influence on use of the user over the network and achieve better user experience.

Manner C1 and manner C2 may be combined for use, that is, the installation file of the APP to be updated may be downloaded at the preset time, or may also be downloaded when the network data traffic is lower.

In another embodiment, the router may be connected with the terminal to control the terminal to install the downloaded installation file after downloading the installation file of the APP to be updated.

The control module 33 is configured to, in response to detection of a connection established between the target terminal and the router, send the installation file downloaded by the downloading module 32 to the target terminal through the connection for the target terminal to update the APP to be updated by installing the installation file.

In another embodiment, the router is limited in storage capacity, and may not keep the downloaded installation file all the time. FIG. 9 is a block diagram of a device for APP updating according to another exemplary embodiment. As shown in FIG. 9, the device further includes a deletion module 34 configured to, in response to determination that the terminal has updated the APP, has uninstalled the APP or has had an installation file of a higher-version APP, delete a currently stored installation file of the APP.

In the embodiment, the deletion module 34 deletes the installation file of the updated or uninstalled APP of the terminal, so that a storage space of the router is effectively saved, and waste of network data traffic is reduced.

In another embodiment, for improving downloading efficiency of the router and avoiding downloading of a useless APP installation file, the router may screen out the APP in the APP list to be updated.

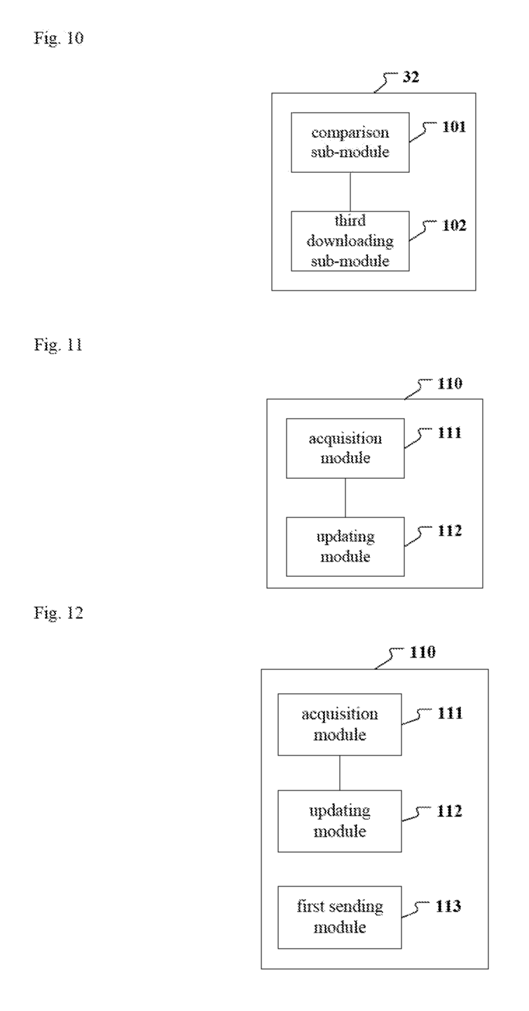

FIG. 10 is a block diagram of an acquisition module according to an exemplary embodiment. As shown in FIG. 10, the downloading module 32 includes a comparison sub-module 101 configured to compare an APP corresponding to a downloaded installation file with an APP in the APP list to be updated, and a third downloading sub-module 102 configured to, in response to determination of the comparison sub-module that there does not exist locally the installation file of the APP in the APP list to be updated, download the installation file of the APP from the network side.

For example, APPs corresponding to locally downloaded installation files are APP3, APP6, and APP9. APPs in the APP list to be updated include APP1, APP2, APP3, APP4 and APP5. After the comparison sub-module 101 performs comparison, if an installation file configured for updating APP3 has been downloaded, then the third downloading sub-module 102 will not download the installation file of APP3, and only downloads installation files of the APPs including APP1, APP2, APP4, and APP5.

In the embodiment, the comparison sub-module 101 compares the APP corresponding to the downloaded installation file with an APP in the APP list to be updated, and the third downloading sub-module 102 downloads the installation file of the APP from the network side according to a comparison result. Therefore, the downloading efficiency of the router is improved, downloading of the useless APP installation file is avoided, and waste of network data traffic is reduced.

An embodiment of the present disclosure further provides a device for APP updating, which should be configured as a terminal. FIG. 11 is a block diagram of a device for APP updating according to an exemplary embodiment. The device may be implemented as part or all of electronic equipment by virtue of software, hardware or a combination of the two. As shown in FIG. 11, the device 110 includes an acquisition module 111 configured to acquire an installation file of an APP to be updated from a router, and an updating module 112, configured to update the APP to be updated according to the installation file acquired by the acquisition module.

In the embodiment, when the terminal updates an APP, the acquisition module 111 acquires an installation file from the router, and the updating module 112 updates the APP according to the installation file. In such a manner, data may be directly downloaded from the router faster, so that an APP updating speed is increased, and moreover, for a user, network congestion caused by centralized downloading of installation files may be avoided. In addition, a silent manner is still adopted for an APP updating process, that is, the user is not required to execute upgrading installation operation, and the terminal automatically updates the APP.

In another embodiment, the terminal may control the router to acquire an APP list to be updated in manners as follows.

Manner D1: the terminal periodically sends APP information to the router, and the router detects an APP to be updated and generates an APP list to be updated.

FIG. 12 is a block diagram of a device for APP updating according to another exemplary embodiment. As shown in FIG. 12, the device 110 further includes a first sending module 113 configured to periodically send local APP information to the router, the APP information including an APP identifier and a version number, to enable the router to monitor the APP to be updated according to the APP information, generate the APP list to be updated and download the installation file of the APP to be updated.

In manner D1, the terminal periodically sends the local APP identifier and version number to the router through the first sending module 113, and the router determines the APP to be updated by itself and generates the APP list to be updated. Therefore, the router can download the installation file of the APP to be updated in advance and then the terminal can acquire the installation file from the router when updating the APP. In such a manner, data may be directly downloaded from the router faster, so that the APP updating speed is increased, and moreover, for the user, network congestion caused by the centralized downloading of the installation files may be avoided. In addition, the silent manner is still adopted for the APP updating process, that is, the user is not required to execute the upgrading installation operation, and the terminal automatically updates the APP.

Manner D2: the terminal generates the APP list to be updated and sends the APP list to be updated to the router.

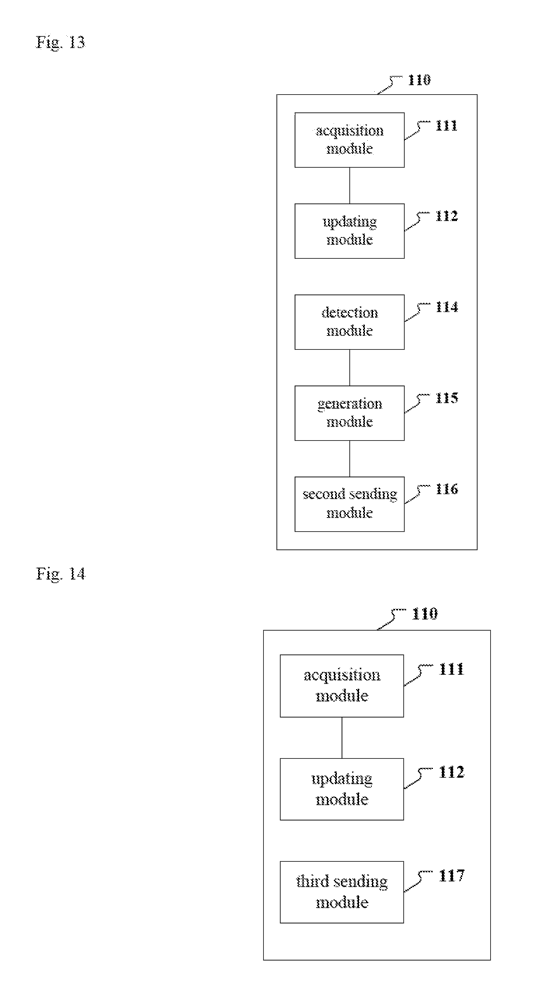

FIG. 13 is a block diagram of a device for APP updating according to another exemplary embodiment. As shown in FIG. 13, the device 110 further includes a detection module 114 configured to periodically detect the local APP to be updated, a generation module 115, configured to generate the APP list to be updated according to the APP to be updated detected by the detection module, and a second sending module 116, configured to send the APP list to be updated generated by the generation module to the router.

In manner D2, the terminal determines the APP to be updated through the detection module 114, the generation module 115 generates the APP list to be updated, and the second sending module 116 sends the APP list to be updated to the router. Therefore, the router can download the installation file of the APP to be updated in advance and then the terminal can acquire the installation file from the router when updating the APP. In such a manner, data may be directly downloaded from the router faster, so that the APP updating speed is increased, and moreover, for the user, network congestion caused by the centralized downloading of the installation files may be avoided. In addition, the silent manner is still adopted for the APP updating process, that is, the user is not required to execute the upgrading installation operation, and the terminal automatically updates the APP.

Manner D3: the terminal periodically sends the APP information to a network side, and the network side generates the APP list to be updated and sends the APP list to be updated to the router.

FIG. 14 is a block diagram of a device for APP updating according to another exemplary embodiment. As shown in FIG. 14, the device further includes a third sending module 117 configured to periodically send the local APP information to the network side, the APP information including an APP identifier and a version number, to enable the network side to determine the APP to be updated of a terminal according to the APP information, generate the APP list to be updated and send the APP list to be updated to the router.

In manner D3, the terminal periodically sends the local APP identifier and version number to the network side through the third sending module 117, and the network side queries a version of the corresponding APP in an APP store to determine the APP to be updated, generate the APP list to be updated and send the APP list to be updated to the router. In such a manner, the router can download the installation file of the APP to be updated in advance and then the terminal can acquire the installation file from the router when updating the APP. Since data may be directly downloaded from the router faster, so that the APP updating speed is increased, and moreover, for the user, network congestion caused by the centralized downloading of the installation files may be avoided. In addition, the silent manner is still adopted for the APP updating process, that is, the user is not required to execute the upgrading installation operation, and the terminal automatically updates the APP.

In addition, the network side may query a version state of the APP in real time, so that the network side may determine the APP to be updated more accurately and comprehensively.

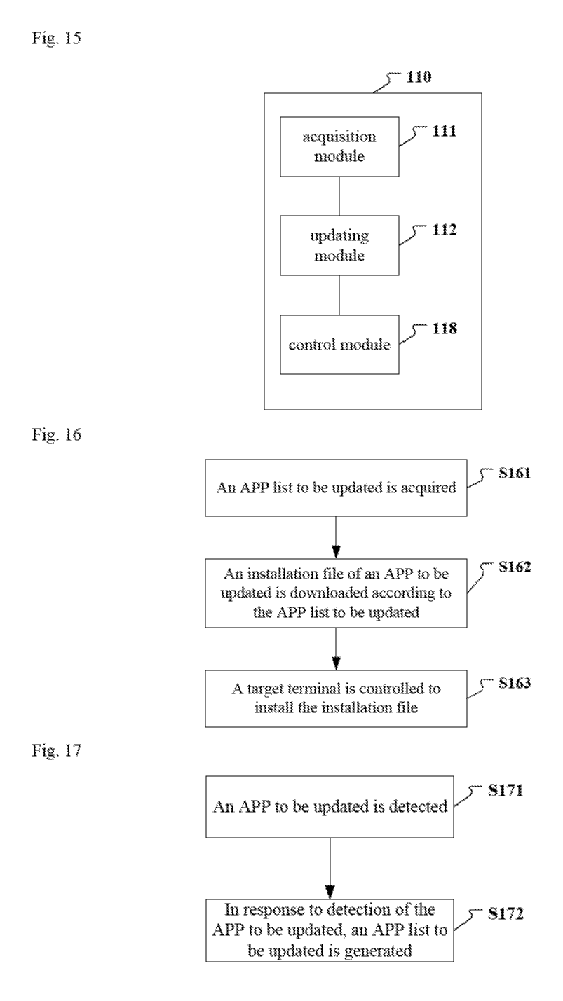

In another embodiment, the router is limited in storage capacity, and may not keep the downloaded installation file all the time. FIG. 15 is a block diagram of a device for APP updating according to another exemplary embodiment. As shown in FIG. 15, the device further includes a control module 118 configured to, in response to determination that the APP to be updated has been updated or the APP to be updated has been uninstalled, control the router to delete the installation file.

In the embodiment, the terminal controls the router to delete the installation file of the updated or uninstalled APP through the control module 118, so that a storage space of the router is effectively saved.

An embodiment of the present disclosure provides a method for APP updating. A router downloads an installation file according to an APP list to be updated, and a terminal directly acquires the installation file from the router for updating.

The methods for APP updating, which are executed on a router side and a terminal side respectively, are described below.

On the router side, FIG. 16 is a flow chart showing a method for APP updating according to an exemplary embodiment. As shown in FIG. 16, the method for APP updating is applied to a router, and includes the following steps:

Step S161: an APP list to be updated is acquired;

Step S162: an installation file of an APP to be updated is downloaded according to the APP list to be updated; and

Step S163: a target terminal is controlled to install the installation file.

For example, the APP list to be updated acquired by the router includes five APPs to be updated: APP1, APP2, APP3, APP4 and APP5. The router downloads installation files of the five APPs to be updated from a network side. The terminal may directly acquire the installation files of the APPs to be updated from the router for updating.

In the embodiment, the router downloads the installation files of the APPs to be updated in advance, and the terminal acquires the installation files from the router when updating the APPs. In such a manner, data may be directly downloaded from the router faster, so that an APP updating speed is increased, and moreover, for a user, network congestion caused by centralized downloading of installation files may be avoided. In addition, a silent manner is still adopted for an APP updating process, that is, the user is not required to execute upgrading installation operation, and the terminal automatically updates the APP.

In another embodiment, there may be multiple manners for the router to acquire the APP list to be updated, and are specifically described below.

Manner E1: the router detects the APPs to be updated, and generates the APP list to be updated.

FIG. 17 is a flow chart showing a method for APP updating according to another exemplary embodiment. As shown in FIG. 17, the step that the APP list to be updated is acquired includes the following:

Step S171: an APP to be updated is detected; and

Step S172: in response to detection of the APP to be updated, an APP list to be updated is generated.

In manner E1, the terminal periodically sends local APP identifier and version number to the router, and the router determines the APP to be updated by itself, and generates the APP list to be updated. In such a manner, the router can download the installation file of the APP to be updated in advance and then the terminal can acquire the installation file from the router when updating the APP. Since data may be directly downloaded from the router faster, the APP updating speed is increased, and moreover, for the user, network congestion caused by the centralized downloading of the installation files may be avoided. In addition, the silent manner is still adopted for the APP updating process, that is, the user is not required to execute the upgrading installation operation, and the terminal automatically updates the APP.

Manner E2: the terminal generates the APP list to be updated, and sends the APP list to be updated to the router.

Here, the step that the APP list to be updated is acquired includes that the APP list to be updated sent by the target terminal is acquired.

In manner E2, the terminal determines the APP to be updated by itself, generates the APP list to be updated and sends the APP list to be updated to the router. Therefore, the router can download the installation file of the APP to be updated in advance and then the terminal can acquire the installation file from the router when updating the APP. In such a manner, data may be directly downloaded from the router faster, so that the APP updating speed is increased, and moreover, for the user, network congestion caused by the centralized downloading of the installation files may be avoided. In addition, the silent manner is still adopted for the APP updating process, that is, the user is not required to execute the upgrading installation operation, and the terminal automatically updates the APP.

Manner E3: the network side generates the APP list to be updated, and sends the APP list to be updated to the router.

Here, the step that the APP list to be updated is acquired includes that the APP list to be updated sent by the network side is acquired.

In manner E3, the terminal periodically sends the local APP identifier and version number to the network side, and the network side queries a version of the corresponding APP in an APP store to determine the APP to be updated, generate the APP list to be updated and send the APP list to be updated to the router. In such a manner, it is also achieved that the router downloads the installation file of the APP to be updated in advance and then the terminal acquires the installation file from the router when updating the APP. Since data may be directly downloaded from the router faster, the APP updating speed is increased, and moreover, for the user, network congestion caused by the centralized downloading of the installation files may be avoided. In addition, the silent manner is still adopted for the APP updating process, that is, the user is not required to execute the upgrading installation operation, and the terminal automatically updates the APP.

In any one of the abovementioned three manners, the router can acquire the APP list to be updated. Any two manners in the three manners or the three manners may also be combined to enable the router to acquire the APP list to be updated. If the router acquires multiple APP lists to be updated, the router may compare APPs in each list to finally determine an APP of which an installation file is required to be downloaded.

In another embodiment, the router may choose when to download the installation file of the APP to be updated, and there may be multiple manners as follows.

Manner F1: the installation file is downloaded at preset time.

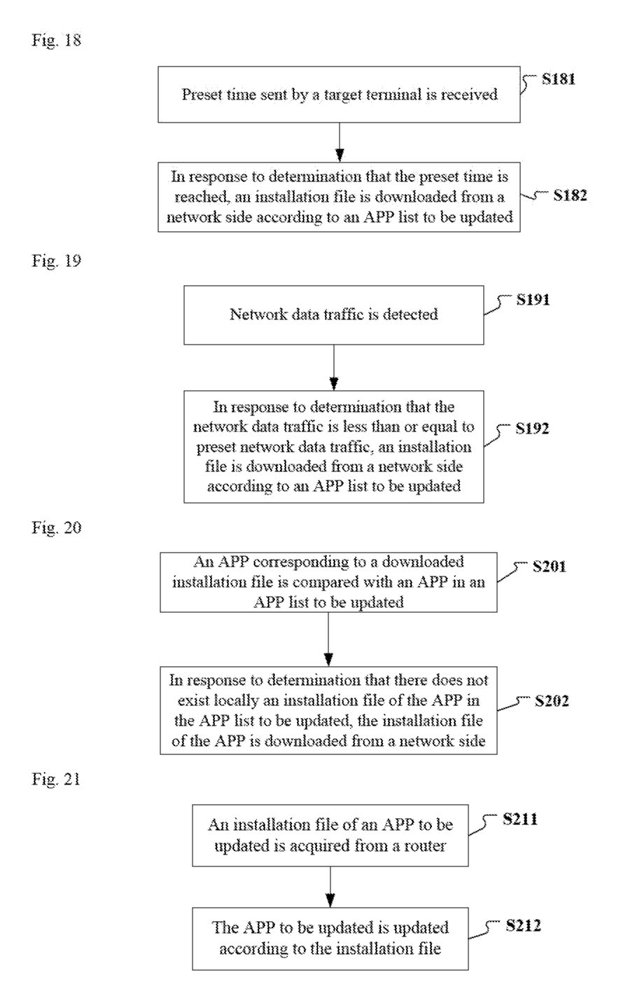

FIG. 18 is a flow chart showing a method for APP updating according to another exemplary embodiment. As shown in FIG. 18, the step that the installation file of the APP to be updated is downloaded according to the APP list to be updated includes the following:

Step S181: the preset time sent by the target terminal is received; and

Step S182: in response to determination that the preset time is reached, the installation file is downloaded from the network side according to the APP list to be updated.

For example, the user may make such a setting that the router executes downloading of the installation file between 12:00 PM and 5:00 AM through the terminal, and during this time, the user is usually in a sleep state and may not use a network, and the router is relatively idle, so that downloading during this time may avoid network congestion and influence on use of the user over the network, and better user experience may be achieved.

In manner F1, the installation file is downloaded according to the received preset time to avoid network congestion and influence on the use of the user over the network and achieve better user experience.

Manner F2: the installation file is downloaded during idle time of the router.

FIG. 19 is a flow chart showing a method for APP updating according to another exemplary embodiment. As shown in FIG. 19, the step that the installation file of the APP to be updated is downloaded according to the APP list to be updated includes the following:

Step S191: network data traffic is detected; and

Step S192: in response to determination that the network data traffic is less than or equal to preset network data traffic, the installation file is downloaded from the network side according to the APP list to be updated.

For example, when the network data traffic is detected to be lower than 10 kb/s, the router is relatively idle, and the installation file of the APP to be updated may be downloaded to avoid network congestion and influence on use of the user over the network and achieve better user experience.

In manner F2, whether to download the installation file or not is determined according to the detected network data traffic, so that network congestion and influence on use of the user over the network are avoided, and better user experience is achieved.

Manner F1 and manner F2 may be combined for use, that is, the installation file of the APP to be updated may be downloaded at the preset time, or may also be downloaded when the network data traffic is lower.

In another embodiment, the router may be connected with the terminal to control the terminal to install the downloaded installation file after downloading the installation file of the APP to be updated. The step that the target terminal is controlled to install the installation file includes that in response to detection of a connection established between the target terminal and the router, the installation file is sent to the target terminal through the connection for the target terminal to update the APP to be updated by installing the installation file.

In another embodiment, the router is limited in storage capacity, and may not keep the downloaded installation file all the time. Optionally, the method for APP updating further includes that in response to determination that the terminal has updated the APP, has uninstalled the APP or has had an installation file of a higher-version APP, a currently stored installation file of the APP is deleted.

In the embodiment, deleting the installation file of the updated or uninstalled APP of the terminal effectively saves a storage space of the router and reduces waste of network data traffic.

In another embodiment, for improving downloading efficiency of the router and avoiding downloading of a useless APP installation file, the router may screen out an APP in the APP to be updated. FIG. 20 is a flow chart showing a method for APP updating according to another exemplary embodiment. As shown in FIG. 20, the step that the installation file is downloaded from the network side according to the APP list to be updated includes the following:

Step S201: an APP corresponding to the downloaded installation file is compared with an APP in the APP list to be updated; and

Step S202: in response to determination that there does not exist locally an installation file of the APP in the APP list to be updated, the installation file of the APP is downloaded from the network side.

For example, APPs corresponding to locally downloaded installation files APP3, APP6 and APP9. APPs in the APP list to be updated include APP1, APP2, APP3, APP4 and APP5. After comparison, if an installation file configured for updating APP3 has been downloaded, then the installation file of APP3 will not be downloaded, and only installation files of the APPs including APP1, APP2, APP4 and APP5 are installed.

In the embodiment, the APP corresponding to the downloaded installation file is compared with an APP in the APP list to be updated, and the installation file of the APP is downloaded from the network side according to a comparison result. Therefore, the downloading efficiency of the router is improved, downloading of the useless APP installation file is avoided, and waste of network data traffic is reduced.

On the terminal side, FIG. 21 is a flow chart showing a method for APP updating according to an exemplary embodiment. As shown in FIG. 21, the method for APP updating is applied to a terminal, and includes the following steps:

Step S211: an installation file of an APP to be updated is acquired from a router; and

Step S212: the APP to be updated is updated according to the installation file.

In the embodiment, when the terminal updates an APP, the terminal acquires an installation file from the router, and updates the APP according to the installation file. In such a manner, data may be directly downloaded from the router faster, so that an APP updating speed is increased, and moreover, for a user, network congestion caused by centralized downloading of installation files may be avoided. In addition, a silent manner is still adopted for an APP updating process, that is, the user is not required to execute upgrading installation operation, and the terminal automatically updates the APP.

In another embodiment, the terminal may control the router to acquire an APP list to be updated in manners as follows.

Manner G1: the terminal periodically sends APP information to the router, and the router detects an APP to be updated and generates an APP list to be updated.

Optionally, the method for APP updating further includes that local APP information is periodically sent to the router, the APP information including an APP identifier and a version number, to enable the router to monitor the APP to be updated according to the APP information, generate the APP list to be updated and download the installation file of the APP to be updated.

In manner G1, the terminal periodically sends the local APP identifier and version number to the router, and the router determines the APP to be updated by itself and generates the APP list to be updated. Therefore, the router can download the installation file of the APP to be updated in advance and then the terminal can acquire the installation file from the router when updating the APP. In such a manner, data may be directly downloaded from the router faster, so that the APP updating speed is increased, and moreover, for a user, network congestion caused by the centralized downloading of the installation files may be avoided. In addition, the silent manner is still adopted for the APP updating process, that is, the user is not required to execute the upgrading installation operation, and the terminal automatically updates the APP.

Manner G2: the terminal generates the APP list to be updated and sends the APP list to be updated to the router.

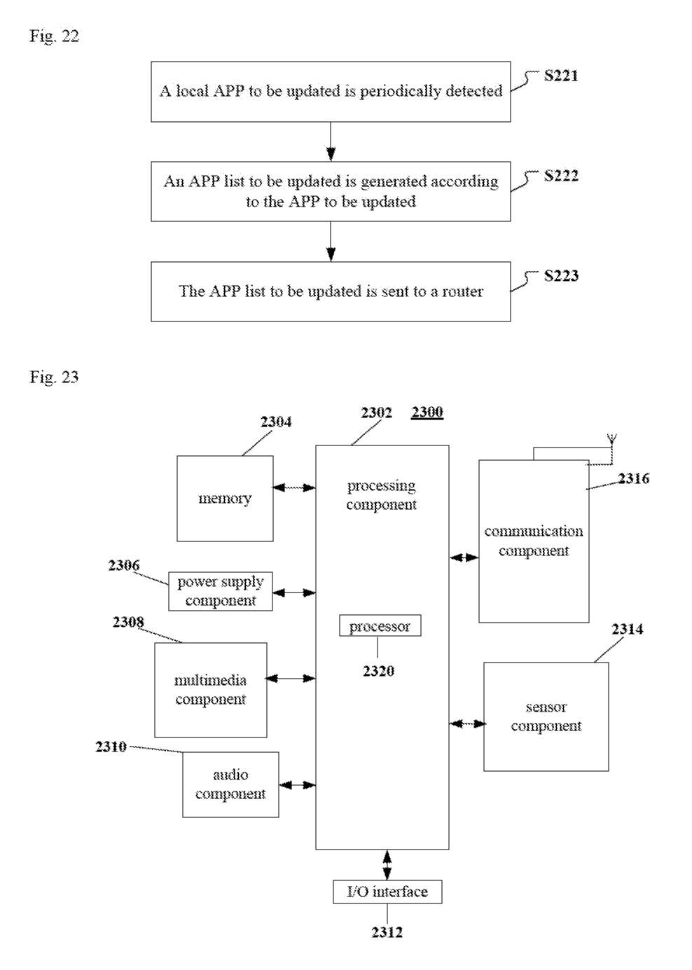

FIG. 22 is a flow chart showing a method for APP updating according to an exemplary embodiment. As shown in FIG. 22, the method for APP updating further includes the following:

Step S221: a local APP to be updated is periodically detected;

Step S222: an APP list to be updated is generated according to the APP to be updated; and

Step S223: the APP list to be updated is sent to the router.

In manner G2, the terminal determines an APP to be updated, generates an APP list to be updated and sends the APP list to be updated to the router. Therefore, the router can download the installation file of the APP to be updated in advance and then the terminal can acquire the installation file from the router when updating the APP. In such a manner, data may be directly downloaded from the router faster, so that the APP updating speed is increased, and moreover, for the user, network congestion caused by the centralized downloading of the installation files may be avoided. In addition, the silent manner is still adopted for the APP updating process, that is, the user is not required to execute the upgrading installation operation, and the terminal automatically updates the APP.

Manner G3: the terminal periodically sends APP information to a network side, and the network side generates the APP list to be updated and sends the APP list to be updated to the router.

Optionally, the method for APP updating further includes that local APP information is periodically sent to the network side, the APP information including an APP identifier and a version number, to enable the network side to determine the APP to be updated of a terminal according to the APP information, generate the APP list to be updated and send the APP list to be updated to the router.

In manner G3, the terminal periodically sends the local APP identifier and version number to the network side through a third sending module 117, and the network side queries a version of the corresponding APP in an APP store to determine the APP to be updated, generate the APP list to be updated and send the APP list to be updated to the router. In such a manner, it is also achieved that the router downloads the installation file of the APP to be updated in advance and then the terminal acquires the installation file from the router when updating the APP. Since data may be directly downloaded from the router faster, the APP updating speed is increased, and moreover, for a user, network congestion caused by the centralized downloading of the installation files may be avoided. In addition, a silent manner is still adopted for the APP updating process, that is, the user is not required to execute the upgrading installation operation, and the terminal automatically updates the APP.

In addition, the network side may query a version state of the APP in real time, so that the network side may determine the APP to be updated more accurately and comprehensively.

In another embodiment, the router is limited in storage capacity, and may not keep the downloaded installation file all the time. Therefore, the method for APP updating further includes that in response to determination that the APP to be updated has been updated or the APP to be updated has been uninstalled, the router is controlled to delete the installation file.

In the embodiment, the terminal controls the router to delete the installation file of the updated or uninstalled APP, so that a storage space of the router is effectively saved.

An embodiment of the present disclosure further provides a device for APP updating, including a processor, and a memory configured to store an instruction executable by the processor. The processor is configured to acquire an APP list to be updated, download an installation file of an APP to be updated according to the APP list to be updated, and control a target terminal to install the installation file.

An embodiment of the present disclosure further provides a device for APP updating, including a processor; and a memory configured to store an instruction executable by the processor, wherein the processor may be configured to acquire an installation file of an APP to be updated from a router; and update the APP to be updated according to the installation file.

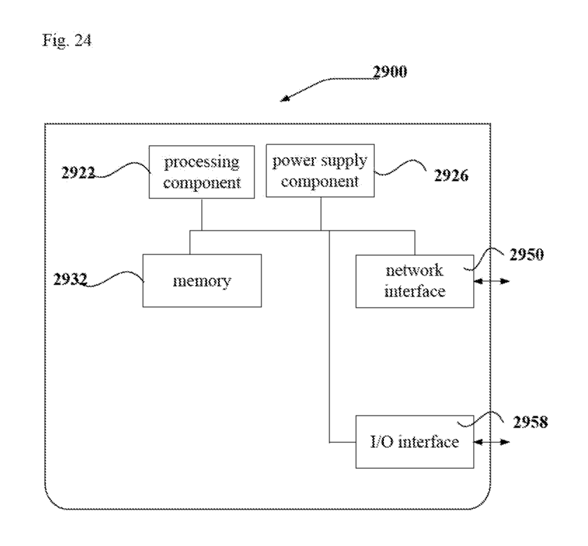

FIG. 23 is a block diagram of a device for APP updating according to an exemplary embodiment. The device is applicable to terminal equipment. For example, the device 2300 may be a video camera, sound recording equipment, a mobile phone, a computer, a digital broadcast terminal, a messaging device, a gaming console, a tablet device, a medical device, fitness equipment, a personal digital assistant and the like.

The device 2300 may include one or more of the following components: a processing component 2302, a memory 2304, a power component 2306, a multimedia component 2308, an audio component 2310, an Input/Output (I/O) interface 2312, a sensor component 2314, and a communication component 2316.

The processing component 2302 typically controls overall operations of the device 2300, such as the operations associated with display, telephone calls, data communications, camera operations, and recording operations. The processing component 2302 may include one or more processors 2320 to execute instructions to perform all or part of the steps in the abovementioned methods. Moreover, the processing component 2302 may include one or more modules which facilitate interaction between the processing component 2302 and the other components. For instance, the processing component 2302 may include a multimedia module to facilitate interaction between the multimedia component 2308 and the processing component 2302.

The memory 2304 is configured to store various types of data to support the operation of the device 2300. Examples of such data include instructions for any applications or methods operated on the device 2300, data of contacts, phonebook data, messages, pictures, video, etc. The memory 2304 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power component 2306 provides power for various components of the device 2300. The power component 2306 may include a power management system, one or more power sources, and any other components associated with the generation, management and distribution of power for the device 2300.

The multimedia component 2308 includes a screen providing an output interface between the device 2300 and a user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action, but also sense a duration and pressure associated with the touch or swipe action. In some embodiments, the multimedia component 2308 includes a front camera and/or a rear camera. The front camera and/or the rear camera may receive external multimedia data when the device 2300 is in an operation mode, such as a photographing mode or a video mode. Each of the front camera and the rear camera may be a fixed optical lens system or have focusing and optical zooming capabilities.

The audio component 2310 is configured to output and/or input an audio signal. For example, the audio component 2310 includes a microphone (MIC), and the MIC is configured to receive an external audio signal when the device 2300 is in the operation mode, such as a call mode, a recording mode and a voice recognition mode. The received audio signal may be further stored in the memory 2304 or sent through the communication component 2316. In some embodiments, the audio component 2310 further includes a speaker configured to output audio signals.

The I/O interface 2312 provides an interface between the processing component 2302 and a peripheral interface module, and the peripheral interface module may be a keyboard, a click wheel, a button and the like. The button may include, but not limited to: a home button, a volume button, a starting button and a locking button.

The sensor component 2314 includes one or more sensors configured to provide status assessment in various aspects for the device 2300. For instance, the sensor component 2314 may detect an open/closed status of the device 2300 and relative positioning of components, such as the display and the keypad of the device 2300, and the sensor component 2314 may further detect a change in position of the device 2300 or a component of the device 2300, a presence or absence of user contact with the device 2300, an orientation or an acceleration/deceleration of the device 2300 and a change in temperature of the device 2300. The sensor component 2314 may include a proximity sensor configured to detect presence of an nearby object without any physical contact. The sensor component 2314 may also include a light sensor, such as a Complementary Metal Oxide Semiconductor (CMOS) or Charge Coupled Device (CCD) image sensor, configured for use in imaging applications. In some embodiments, the sensor component 2314 may also include an acceleration sensor, a gyroscope sensor, a magnetic sensor, a pressure sensor or a temperature sensor.

The communication component 2316 is configured to facilitate wired or wireless communication between the device 2300 and other devices. The device 2300 may access a wireless network based on a communication standard, such as WIFI, 2nd-Generation (2G) or 3rd-Generation (3G), or a combination thereof. In an exemplary embodiment, the communication component 2316 receives a broadcast signal or broadcast associated information from an external broadcast management system through a broadcast channel. In an exemplary embodiment, the communication component 2316 further includes a Near Field

Communication (NFC) module to facilitate short-range communications. For example, the NFC module may be implemented on the basis of a Radio Frequency Identification (RFID) technology, an Infrared Data Association (IrDA) technology, an Ultra-WideBand (UWB) technology, a BlueTooth (BT) technology and other technologies.

In an exemplary embodiment, the device 2300 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned methods.

In an exemplary embodiment, there is also provided a non-transitory computer-readable storage medium including an instruction, such as the memory 2304 including an instruction, and the instruction may be executed by the processor 2320 of the device 2300 to implement the abovementioned methods. For example, the non-transitory computer-readable storage medium may be a ROM, a Radom Access Memory (RAM), a Compact Disc Read-Only Memory (CD-ROM), a magnetic tape, a floppy disc, an optical data storage device and the like.

FIG. 24 is a block diagram of a device for APP updating according to an exemplary embodiment. For example, the device 2900 may be a router. The device 2900 includes a processing component 2922, which further includes one or more processors, and a memory resource represented by a memory 2932, configured to store instructions such as APPs executable by the processing component 2922. The APPs stored in the memory 2932 may include one or more than one module. Each module may include a set of instructions. In addition, the processing component 2922 is configured to execute the instructions to execute the abovementioned methods.

The device 2900 may further include a power component 2926 configured to execute power mangement of the device 2900, a wired or wireless network interface 2950 configured to connect the device 2900 to a network, and an I/O interface 2958. The device 2900 may be operated on the basis of an operating system stored in the memory 2932, such as Windows Server™, Mac OS X™, Unix™, Linux™ or FreeBSD™.

According to a non-transitory computer-readable storage medium, when instructions in the storage medium are executed by a processor of the device 2300, the device 2300 may execute the abovementioned method for APP updating, the method including that an installation file of an APP to be updated is acquired from a router, and the APP to be updated is updated according to the installation file.

Optionally, the method further includes that local APP information is periodically sent to the router, the APP information including an APP identifier and a version number, to enable the router to monitor the APP to be updated according to the APP information, generate an APP list to be updated and download the installation file of the APP to be updated.

Optionally, the method further includes that a local APP to be updated is periodically detected, the APP list to be updated is generated according to the APP to be updated, and the APP list to be updated is sent to the router.

Optionally, the method further includes that local APP information is periodically sent to a network side, the APP information including an APP identifier and a version number, to enable the network side to determine the APP to be updated of a terminal according to the APP information, generate the APP list to be updated and send the APP list to be updated to the router.

Optionally, the method further includes that in response to determination that the APP to be updated has been updated or the APP to be updated has been uninstalled, the router is controlled to delete the installation file.

According to a non-transitory computer-readable storage medium, when instructions in the storage medium are executed by a processor of the device 2900, the device 2900 may execute the abovementioned method for APP updating, the method including that an APP list to be updated is acquired, an installation file of an APP to be updated is downloaded according to the APP list to be updated, and a target terminal is controlled to install the installation file.

Optionally, the step that the APP list to be updated is acquired includes that the APP to be updated is detected, and in response to detection of the APP to be updated, the APP list to be updated is generated.

Optionally, the step that the APP list to be updated is acquired includes that the APP list to be updated sent by the target terminal is acquired.

Optionally, the step that the APP list to be updated is acquired includes that the APP list to be updated sent by a network side is acquired.

Optionally, the step that the installation file of the APP to be updated is downloaded according to the APP list to be updated includes that preset time sent by the target terminal is received, and in response to determination that the preset time is reached, the installation file is downloaded from the network side according to the APP list to be updated.

Optionally, the step that the installation file of the APP to be updated is downloaded according to the APP list to be updated includes that network data traffic is detected, and in response to determination that the network data traffic is less than or equal to preset network data traffic, the installation file is downloaded from the network side according to the APP list to be updated.

Optionally, the step that the target terminal is controlled to install the installation file includes that in response to detection of a connection established between the target terminal and a router, the installation file is sent to the target terminal through the connection for the target terminal to update the APP to be updated by installing the installation file.

Optionally, the method further includes that in response to determination that the terminal has updated the APP, has uninstalled the APP or has had an installation file of a higher-version APP, a currently stored installation file of the APP is deleted.

Optionally, the step that the installation file is downloaded from the network side according to the APP list to be updated includes that an APP corresponding to the downloaded installation file is compared with an APP in the APP list to be updated, and in response to determination that there does not exist locally the installation file of the APP in the APP list to be updated, the installation file of the APP is downloaded from the network side.

In an embodiment, a router downloads an installation file of an APP to be updated in advance, and a terminal acquires the installation file from the router when updating the APP. In such a manner, data may be directly downloaded from the router faster, so that an APP updating speed is increased, and moreover, for a user, network congestion caused by centralized downloading of installation files may be avoided. In addition, a silent manner is still adopted for an APP updating process, that is, the user is not required to execute upgrading installation operation, and the terminal automatically updates the APP.

In another embodiment, the terminal periodically sends local APP identifier and version number to a network side, and the network side queries a version of a corresponding APP in an APP store to determine the APP to be updated, generate an APP list to be updated and send the APP list to be updated to the router. In such a manner, the router can download the installation file of the APP to be updated in advance and then the terminal can acquire the installation file from the router when updating the APP. Since data may be directly downloaded from the router faster, so that the APP updating speed is increased, and moreover, for the user, network congestion caused by the centralized downloading of the installation files may be avoided. In addition, the silent manner is still adopted for the APP updating process, that is, the user is not required to execute the upgrading installation operation, and the terminal automatically updates the APP.

In another embodiment, the terminal determines an APP to be updated by itself, generates an APP list to be updated and sends the APP list to be updated to the router. Therefore, the router can download the installation file of the APP to be updated in advance and then the terminal can acquire the installation file from the router when updating the APP. In such a manner, data may be directly downloaded from the router faster, so that the APP updating speed is increased, and moreover, for the user, network congestion caused by the centralized downloading of the installation files may be avoided. In addition, the silent manner is still adopted for the APP updating process, that is, the user is not required to execute the upgrading installation operation, and the terminal automatically updates the APP.

In another embodiment, the terminal periodically sends local APP identifier and version number to the router, and the router determines an APP to be updated and generates an APP list to be updated. Therefore, the router can download the installation file of the APP to be updated in advance and then the terminal can acquire the installation file from the router when updating the APP. In such a manner, data may be directly downloaded from the router faster, so that the APP updating speed is increased, and moreover, for the user, network congestion caused by the centralized downloading of the installation files may be avoided. In addition, the silent manner is still adopted for the APP updating process, that is, the user is not required to execute the upgrading installation operation, and the terminal automatically updates the APP.

In another embodiment, the router does not keep the installation file of the updated or uninstalled APP of the terminal, so that a storage space of the router is effectively saved.

In another embodiment, an APP corresponding to a downloaded installation file is compared with an APP in an APP list to be updated, and the installation file of the APP is downloaded from a network side according to a comparison result. Therefore, downloading efficiency of the router is improved, downloading of a useless APP installation file is avoided, and waste of network data traffic is reduced.

Other embodiments of the present disclosure will be apparent to those skilled in the art from consideration of the specification and practice of the embodiments of the present disclosure disclosed here. This application is intended to cover any variations, uses, or adaptations of the embodiments of the present disclosure following the general principles thereof and including such departures from the embodiments of the present disclosure as come within known or customary practice in the art. It is intended that the specification and examples be considered as exemplary only, with a true scope and spirit of the embodiments of the present disclosure being indicated by the following claims.

It will be appreciated that the embodiments of the present disclosure are not limited to the exact construction that has been described above and illustrated in the accompanying drawings, and that various modifications and changes may be made without departing from the scope thereof. It is intended that the scope of the embodiments of the present disclosure only be limited by the appended claims.

What is claimed is:

1. A method for Application (APP) updating, applied to a router, the method comprising:
acquiring an APP list that includes each APP to be updated that are sent to the router via a network;
downloading an installation file at a predetermined amount of time prior to installation of each APP in the APP list, each installation file being downloaded from the network; and
controlling a target terminal to automatically install each installation file at a predetermined installation time, such that a user is not required to execute any upgrading installation operation.

2. The method according to claim 1, wherein acquiring the APP list to be updated further comprises:
detecting the APP to be updated based on APP information sent to the network periodically from the target terminal, the information including a version state of the APP queried in real time by the target terminal; and
generating the APP list in response to each APP to be updated being sent from the network to the router.

3. The method according to claim 1, wherein acquiring the APP list to be updated comprises:
acquiring the APP list from the target terminal, the target terminal independently generating the APP list.

4. The method according to claim 1, wherein acquiring the APP list to be updated comprises:
acquiring the APP list from the network.

5. The method according to claim 1, wherein downloading the installation file of the APP to be updated according to the APP list to be updated further comprises:
receiving from the target terminal a predetermined time at which the installation file is to be downloaded; and
downloading the installation file from a the network according to the APPs to be updated in the APP list at the predetermined time.

6. The method according to claim 1, wherein downloading the installation file of the APP to be updated according to the APP list to be updated further comprises:
detecting network data traffic; and
downloading the installation file from a the network according to the APPs to be updated in the APP list in response to the network data traffic being less than or equal to a predetermined amount of network data traffic.

7. The method according to claim 1, wherein controlling the target terminal to install the installation file comprises:
transmitting the installation file to the target terminal to update the APPs to be updated in the APP list by installing the installation file in response to an established connection detected between the target terminal and the router.

8. The method according to claim 1, further comprising:
deleting a currently stored installation file of the APP, in response to at least one of the target terminal updating the APP, the target terminal uninstalling the APP, or installing an installation file associated with a more recent version of the APP.

9. The method according to claim 1, wherein downloading the installation file according to the APP list to be updated further comprises:
comparing an APP corresponding to a downloaded installation file with an APP in the APP list to be updated when the router acquires multiple APP lists; and
downloading the installation file of the APP from & the network when the comparison determines that the APP corresponding to the downloaded installation file does not exist on the target terminal.

10. A device for Application (APP) updating, comprising:
a processor; and
a memory configured to store an instruction executable by the processor, wherein the processor is configured to:
acquire an APP list that includes each APP to be updated that are sent to the router via a network;
download an installation file at a predetermined amount of time prior to installation of each APP in the APP list, each installation file being downloaded from the network; and
control a target terminal to automatically install each installation file at a predetermined installation time, such that a user is not required to execute any upgrading installation operation.

11. The device for APP updating according to claim 10, wherein the processing circuitry acquiring the APP list to be updated is further configured to:
detect the APP to be updated based on APP information sent to the network periodically from the target terminal, the information including a version state of the APP queried in real time by the target terminal, and
generate the APP list in response to each APP to be updated being sent from the network to the router.

12. The device for APP updating according to claim 10, wherein the processing circuitry acquiring the APP list to be updated is further configured to:
acquire the APP list from the target terminal, the target terminal independently generating the APP list.

13. The device for APP updating according to claim 10, wherein the processing circuitry acquiring the APP list to be updated is further configured to:
acquire the APP list from the network.

14. The device for APP updating according to claim 10, wherein the processing circuitry downloading the installation file of the APP to be updated according to the APP list to be updated is further configured to:
receive from the target terminal a predetermined time at which the installation file is to be downloaded, and
download the installation file from the network according to the APPs to be updated in the APP list.

15. The device for APP updating according to claim 10, wherein the processing circuitry downloading the installation file of the APP to be updated according to the APP list to be updated is further configured to:
detect network data traffic, and
download the installation file from the network according to the APPs to be updated in the APP list in response to the network data traffic being less than or equal to a predetermined amount of network data traffic.

16. The device for APP updating according to claim 10, wherein the processing circuitry controlling the target terminal to install the installation file is further configured to:
transmit the installation file to the target terminal to update the APPs to be updated in the APP list by installing the installation file in response to an established connection detected between the target terminal and the router.

17. The device for APP updating according to claim 10, wherein the processor is further configured to:
delete a currently stored installation file of the APP in response to at least one of the target terminal updating the APP, the target terminal uninstalling the APP, or installing an installation file associated with a more recent version of the APP.

18. The device for APP updating according to claim 14, wherein the processing circuitry downloading the installation file from the network side according to the APP list to be updated is further configured to:
compare an APP corresponding to a downloaded installation file with an APP in the APP list to be updated when the router acquires multiple APP lists, and
download the installation file of the APP from the network when the comparison determines that the APP corresponding to the downloaded installation file does not exist on the target terminal.

19. A non-transitory computer-readable storage medium having stored therein instructions that, when executed by a processor of a terminal, causes the terminal to perform a method for Application (APP) updating, the method comprising:
acquiring an APP list that includes each APP to be updated that are sent to a router via a network;
downloading an installation file at a predetermined amount of time prior to installation of each APP in the APP list, each installation file being downloaded from the network; and
controlling a target terminal to automatically install each installation file at predetermined installation time, such that a user is not required to execute any upgrading installation operation.

20. The non-transitory computer-readable storage medium according to claim 19, wherein acquiring the APP list to be updated comprises:
detecting the APP to be updated based on APP information sent to the network periodically from the target terminal, the information including a version state of the APP queried in real time by the target terminal; and
generating the APP list in response to each APP to be updated being sent from the network to the router.
